(19) United States
(12) Patent Application Publication
(10) Pub. No.: US 2013/0069984 A1
(43) Pub. Date: Mar. 21, 2013

(54) METHOD AND DEVICE FOR SHOWING PAGE TORE-OFF EFFECT

(71) Applicants: CHIA-HAO CHUANG, Tu-Cheng (TW); CHIH-SAN CHIANG, Tu-Cheng (TW); YAO-HUI ZENG, Shenzhen City (CN); YUAN-YUAN JIANG, Shenzhen City (CN); XUE-TAO TAN, Shenzhen City (CN); DA-JUN XIONG, Shenzhen City (CN)

(72) Inventors: CHIA-HAO CHUANG, Tu-Cheng (TW); CHIH-SAN CHIANG, Tu-Cheng (TW); YAO-HUI ZENG, Shenzhen City (CN); YUAN-YUAN JIANG, Shenzhen City (CN); XUE-TAO TAN, Shenzhen City (CN); DA-JUN XIONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/283,620

(22) Filed: Oct. 28, 2011

(30) Foreign Application Priority Data
Sep. 16, 2011 (CN) 201110275171.1

(51) Int. Cl. G09G 5/377

(52) U.S. Cl. 345/629

(57) ABSTRACT

An electronic device includes a storage unit, a touch display unit and a processing unit. The storage unit stores a parameter table comprising a plurality of parameters, and each parameter includes a first group of coordinates to determine the first part of a page and a second group of coordinates to determine the second part of the page. When the user's touch crosses a predetermined area, the processing unit obtains the parameters in sequence, and produces a tear-off-page figure on the first part of a current page, to cover the second part with a second area of the following page to display a combined page. Then the processing unit may store or delete the tore-off page according to a user selection after the next page is displayed in full. A related method is also provided.

### BACKGROUND

1. Technical Field

The present disclosure relates to electronic devices and, particularly, to an electronic device capable of showing page tore-off effect, and a method employed by the device.

2. Description of the Related Art

Electronic book readers and many media players capable of opening e-book files, are capable of storing and displaying electronic documents (e.g., digital images, digital texts, etc). The readability of these electronic devices may deviate greatly from real paper print. Software capable of generating a page tore-off effect similar to tear a printed paper is known. However, when using an electronic reading device installed the software, if users want to store a tore-off page in a new electronic document, or delete a tore-off page from the currently opened electronic document, they have to open an editing interface to store or delete the tore-off page, which may interrupt the reading progress of the user.

### BRIEF DESCRIPTION OF THE DRAWINGS

The components in the drawing are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an electronic device capable of showing page tore-off effect in accordance with an exemplary embodiment.

FIGS. 2-6 are a series of schematic diagrams illustrating the process of tearing a page in accordance with the exemplary embodiment.

FIG. 7 is a schematic view of a user interface for users to make a selection(s) in relation to a page, in accordance with an exemplary embodiment.

FIG. 8 is a flowchart illustrating a method for showing page tore-off effect applied in the electronic device of FIG. 1, in accordance with an exemplary embodiment.

### DETAILED DESCRIPTION

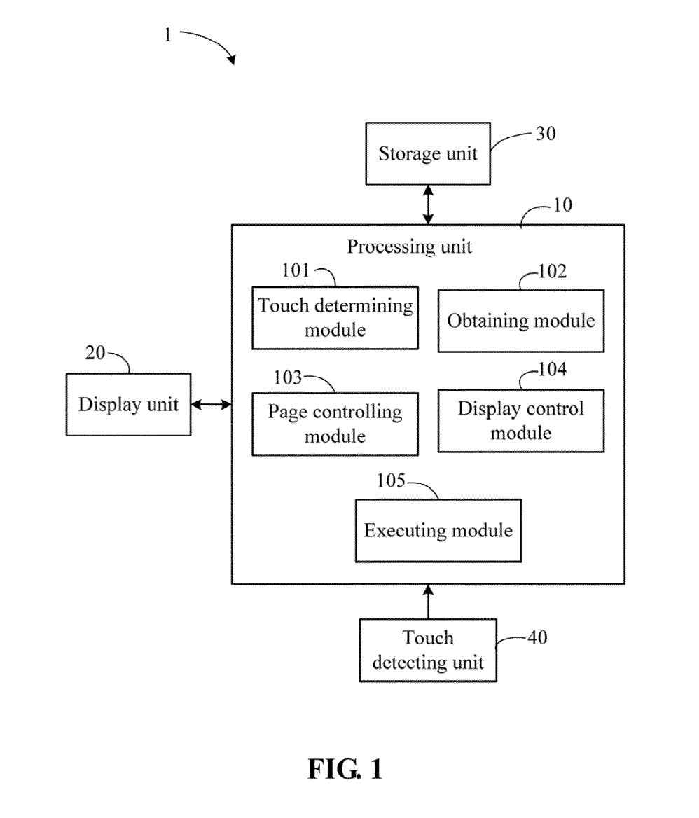

FIG. 1 is a block diagram of an electronic device 1, capable of displaying page tore-off effect in accordance with an exemplary embodiment, and includes a processing unit 10, a display unit 20, a storage unit 30, and a touch detecting unit 40. The electronic device 1 may be a PDA or E-book reader capable of opening e-book files. The display unit 20 may be a touch screen. The touch detecting unit 40 is configured to generate touch signals in response to a touch by a user on the touch display unit 20. The storage unit 30 is configured to store a variety of electronic documents. The electronic documents may include, but are not limited to, audio files, videos, digital images, texts, and any other files in e-book format. The storage unit 30 is further configured to store a table of parameters.

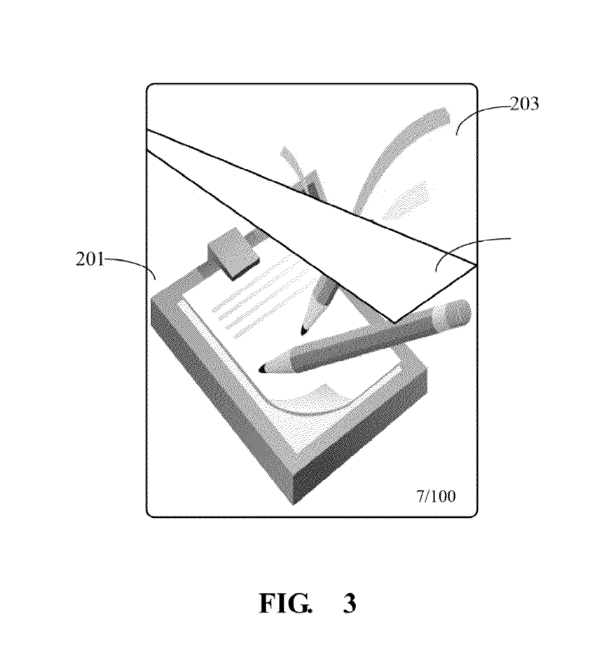

Referring to FIG. 3, each of the parameters includes a first group of coordinates and a second group of coordinates, which define a first screen part 201 and a second screen part 202 correspondingly. In the embodiment, the first part 201 is an area displaying the tore-off-page figure which represents one of the page tore-off effects, such a dog-ear representing a page tore-off effect, wherein the dog-ear can be a triangle, a quadrangle, a pentagon etc. The second part 202 is an area displaying a part of the following page when the currently displayed page has been torn off.

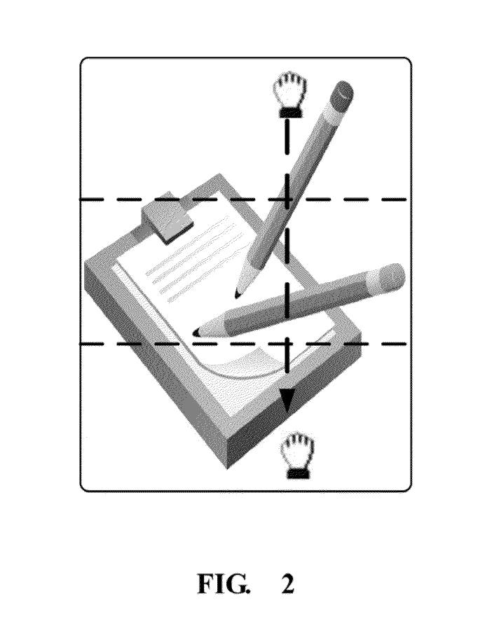

Each of the parameters is pre-numbered in a full page-tearing off process and each is associated with one step of the process of completely tearing off a page. Corresponding to the parameters, a series of combined pages as shown in FIGS. 2-6 may be formed and displayed in sequence.

The processing unit 10 includes a touch determining module 101, an obtaining module 102, a page controlling module 103, and a display control module 104.

Referring to FIGS. 2-6, when a user views an electronic document through the electronic device 1, the user may input a tore-off-page instruction through touching the display unit 20. For example, the current page displayed on the display unit 20 is page 7/100 as shown in FIG. 2, wherein 100 represents the total number of pages of the a current e-book file, and 7 represents the current page. The touch detecting unit 40 generates touch signals in response to the user's touch on the display unit 20. The touch determining module 101 is configured to determine whether the movement of the touch crosses a predetermined area on the touch display unit 20 according to the touch signals from the touch detecting unit 40. If the movement crosses the predetermined area, the obtaining module 102 obtains the first parameter from the table stored in the storage unit 30. The page controlling module 103 is configured to produce the tore-off-page figure on the first part 201 of a currently displayed page according to the first group of coordinates of the obtained parameter. In detail, the page controlling module 103 produces a blank area on the first part 201 determined by the first group coordinates.

The page controlling module 103 determines the second part 202 of the currently displayed page (e.g., 7) and a second part of the following page (e.g., 8) determined by the second group of coordinates of the obtained parameters. The page controlling module 103 covers the determined second part 202 of the currently displayed page using the determined second part of the following page thereby the first part 201 of the currently displayed page and the second part of the following page cooperatively forming a combined page shown in FIG. 3.

The display control module 104 displays the first combined page after the first combined page is combined by the page controlling module 103. The first part 201 of the combined page is the dog-ear, the second part 202 is the portion of the following page (e.g., 8), and a remaining part 203 of the combined page is a portion of the current page (e.g., 7), then, the first combined page displays page 7 apparently torn off at a corner of the page.

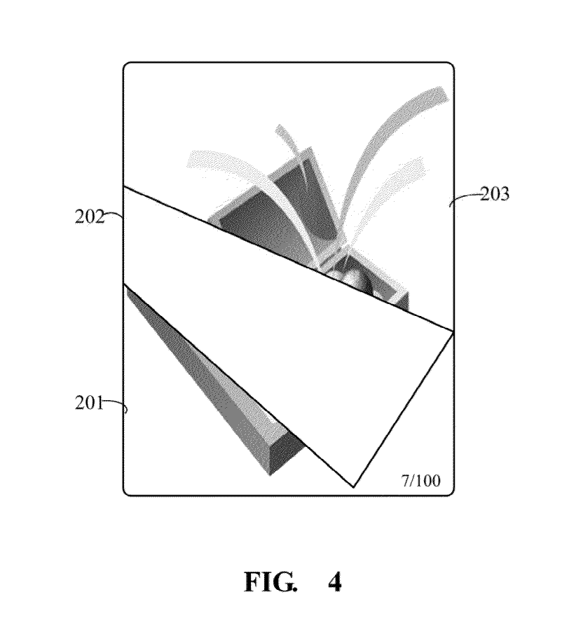

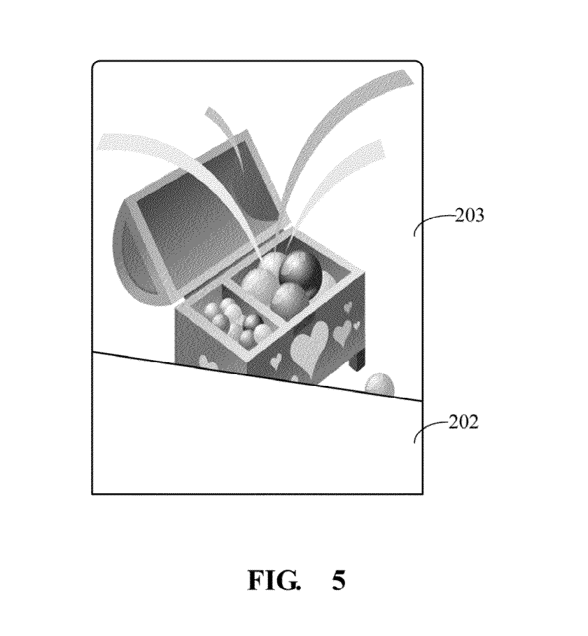

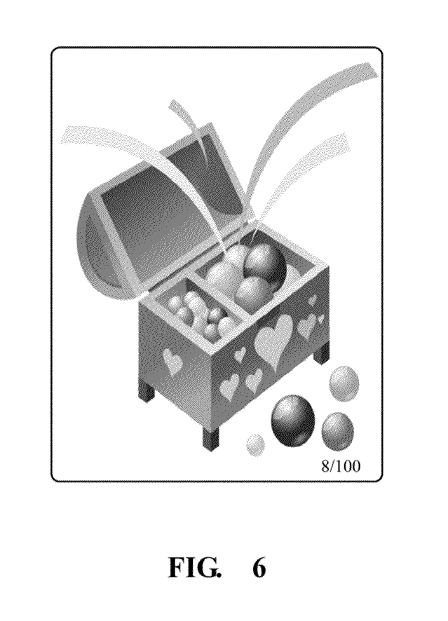

After combining and displaying the first combined page, the obtaining module 102, the page controlling module 103, and the display control module 104 repeat the obtaining, producing, covering, and displaying processes described above, and the display unit 20 accordingly displays a second combined page as shown in FIG. 4, a third combined page as shown in FIG. 5, etc, until the next page (i.e., page 8) is displayed in full, as shown in FIG. 6. By using the series of combined pages in sequence as shown in FIG. 2-6, the display has the appearance of a page being physically torn.

Referring again to FIG. 2, in the embodiment, the display area of the display unit 20 is horizontally divided into three sub-areas. The predetermined area is a sub-area in the middle of the touch display unit 20. When the finger of a user touches and slides on the display unit 20 from the upper sub-area to the lower sub-area, so crossing the middle sub-area, the obtaining module 102, the page controlling module 103, and the display control module 104 executes the obtaining, covering, and displaying processes described above. In an alternative embodiment, the display area of the display unit 20 is divided vertically into three sub-areas. The predetermined area is the sub-area in the middle of the touch display unit 20. When a user touches and slides his finger on the display unit 20 from the left sub-area to the right sub-area, so crossing the middle sub-area, the obtaining module 102, the page controlling module 103, and the display control module 104 execute the obtaining, covering, and displaying processes described above.

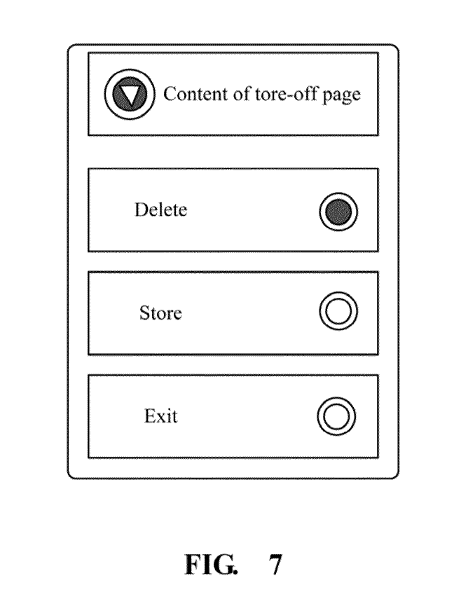

Referring to FIG. 7, the processing unit 10 further includes an executing module 105. When the complete next page is displayed on the display unit 20, the executing module 105 is configured to obtain the content of the tore-off page, and store or delete the content of the tore-off-page according to user's selection determined by the touch determining module 101. The displaying control module 104 displays a user interface on the display unit 20. The user interface displays three options including to store the tore-off-page, to delete the tore-off-page, and to exit the user interface. When the user's selection is determined to store the content, the executing module 103 saves the content as a new electronic document. When the user's selection is determined to delete the content, the executing module 103 deletes the content from the currently displayed electronic document. When the user's selection is determined to exit the user interface, the executing module 103 controls the display unit 20 to hide the user interface.

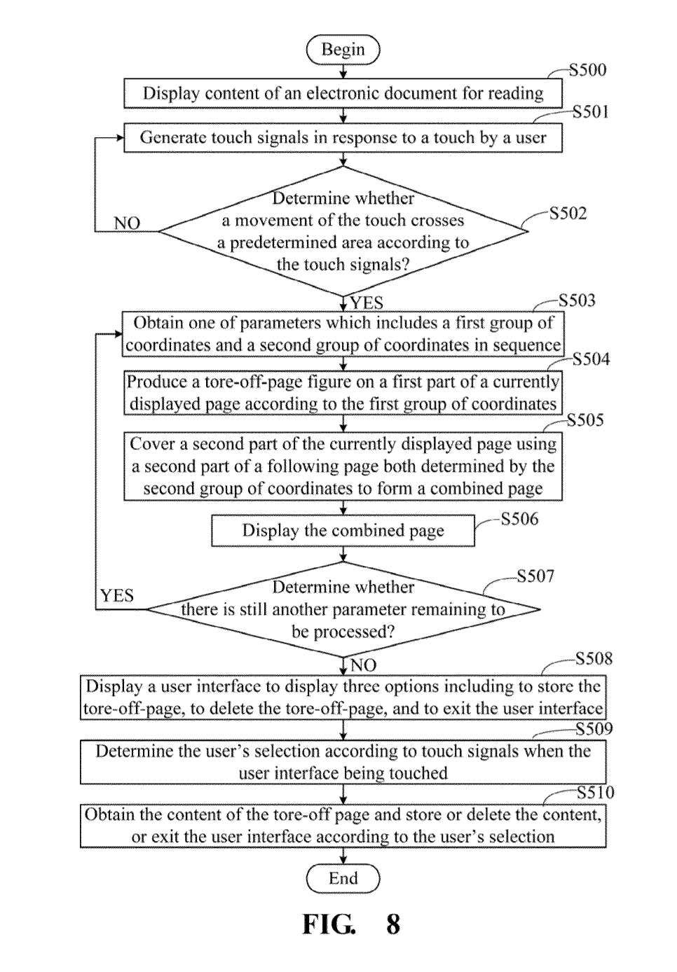

FIG. 8 is a flowchart illustrating a method capable of showing a page tore-off effect applied on the electronic device 1 in accordance with an exemplary embodiment.

In step S500, the page controlling module 102 displays the content of an electronic document on the display unit 20 for reading.

In step S501, the touch detecting unit 40 generates touch signals in response to the touch by a user on the display unit 20.

In step S502, the touch determining module 101 determines whether the movement of the touch crosses the predetermined area on the touch display screen according to the touch signals generated by the touch detecting unit 40. If it does, the procedure goes to step S503; otherwise, the procedure returns to step S501.

In step S503, the obtaining module 102 obtains parameters one by one from the table stored in a sequence based up the touch movement. For example, if the parameter previously obtained was a second parameter, the obtaining module 102 then obtains a third parameter.

In step S504, the page controlling module 103 produces the tore-off-page figure on the first part 201 of the currently displayed page according to the first group of coordinates of one of the obtained parameters. In detail, the page controlling module 103 produces a blank area on the first part 201 determined by the first group coordinates.

In step S505, the page controlling module 103 covers the second part 202 of the currently displayed page determined by the second group of coordinates of one of the obtained parameters using a second part of the following page also determined by the second group of coordinates thereby the first part of the currently displayed page and the second part of the following page cooperatively forming the combined page.

In step S506, the display control module 104 controls the display unit 20 to display the combined page.

In step S507, the obtaining module 102 determines whether or not there is still another parameter remaining to be processed after the display unit 20 has displayed the combined page thereon. If another parameter remains to be processed, the procedure returns to step S503. Otherwise, the procedure goes to step S508.

In step S508, the display control module 104 displays the user interface on the display unit 20 to display three options including to store the tore-off-page, to delete the tore-off-page, and to exit the user interface.

In step S509, the touch determining module 101 determines the user's selection according to the touch signals generated by the touch detecting unit 40.

In step S510, the executing module 103 obtains the content of the tore-off page from the electronic document stored in the storage unit 30, and stores or deletes the content, or exits the user interface according to the user's selection.

When the user's selection is determined to store the content of the tore-off page, the executing module 103 stores the content in a new electronic document. When the user's selection is determined to delete the content of the tore-off page, the executing module 103 deletes the content. When the user's selection is determined to exit the user interface, the executing module 103 exits the user interface.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
a storage unit configured to store electronic documents and a table of parameters, wherein each parameter comprises a first group of coordinates and a second group of coordinates; the first group of coordinates is configured to determine a first part of a page, and the second group of coordinates is configured to determine a second part of the page;
a touch display unit configured to display the electronic documents;
a touch detecting unit configured to generate touch signals in response to a touch by a user on the touch display unit; and
a processing unit comprising:
a touch determining module configured to determine whether the movement of the touch crosses a predetermined area on the touch display unit according to the touch signals from the touch detecting unit;
an obtaining module configured to obtain the parameters one by one from the table in a sequence based up the touch movement, and determine whether there is still another parameter to be processed;
a page controlling module configured to produce a tore-off-page figure on the first part of a currently displayed page according to the first group of coordinates of one of the obtained parameters, and further overlays the second part of the currently displayed page determined by the second group of coordinates of one of the obtained parameters using a second part of the following page determined by the second group of coordinates thereby the first part of the currently displayed page and the second part of the following page cooperatively forming a combined page;
a display control module configured to control the display unit to display the combined page; and
an executing module configured to obtain the content of the tore-off page.

2. The electronic device as recited in claim 1, wherein the predetermined area is a sub-area in the middle of the touch display unit.

3. The electronic device as recited in claim 1, wherein the executing module is further configured to store or delete the content according to user's selection.

4. The electronic device as recited in claim 3, wherein the executing module is further configured to control the display unit to display a user interface displaying three options including to store the tore-off page, to delete the tore-off page, and to exit the user interface, and execute corresponding option according to user's selection determined by the touch determining module.

5. The electronic device as recited in claim 4, wherein when the user's selection is determined to store the content, the executing module stores the content in a new electronic document in the storage unit; when the user's selection is determined to delete the content, the executing module deletes the content from the storage unit; when the user's selection is determined to exit the user interface, the executing module controls the display unit to hide the user interface.

6. A method for showing a page tore-off effect on an electronic device, the electronic device comprising a storage unit storing a table of parameters, and a touch display screen, each of the parameter comprising a first group of coordinates and a second group of coordinates, the first group of coordinates configured to determine a first part of a page displayed on the touch display screen, and the second group of coordinates configured to determine a second part of the page displayed on the touch display screen, the method comprising:
(1) generating touch signals in response to a touch by a user on the display unit;
(2) determining whether the movement of the touch crosses a predetermined area on the touch display unit according to the touch signals;
(3) obtaining parameters one by one from the table in a sequence based up the touch movement;
(4) producing a tore-off-page figure on a first part of a currently displayed page according to the first group of coordinates of one of the obtained parameters;
(5) covering a second part of the currently displayed page determined by the second group of coordinates of one of the obtained parameters using a second part of the following page determined by the second group of coordinates thereby the first part of the currently displayed page and the second part of the following page cooperatively forming a combined page;
(6) displaying the combined page on the touch display screen;
(7) determining whether there is still another parameter remaining to be processed;
(8) obtaining the content of the tore-off page when there is no parameter remaining to be processed.

7. The method as recited in claim 6, further comprising returning to the step (3) when there is still another parameter remains to be processed.

8. The method as recited in claim 6, further comprising storing or deleting the content according to user's selection.

9. The method as recited in claim 6, wherein the predetermined area is a sub-area in the middle of the touch display unit.

10. The method as recited in claim 6, where prior to the step (8), further comprising:
displaying a user interface displaying three options including to store the tore-off-page, to delete tore-off-page, and to exit the user interface; and
determining the user's selection according to the touch signals generated when the user interface being touched.

11. The method as recited in claim 8, further comprising storing the content in a new electronic document when the user's selection is to store the content of the tore-off page.

12. The method as recited in claim 10, further comprising deleting the content when the user's selection is determined to delete the content.

13. The method as recited in claim 10, further comprising exiting the user interface when the user's selection is determined to exit the user interface.
